(19) United States
(12) Patent Application Publication
(10) Pub. No.: US 2018/0319041 A1
(43) Pub. Date: Nov. 8, 2018

(54) CERAMIC CUTTER HAVING LIQUID-COOLING BY IMMERSION OF THE CUTTING DISC

(71) Applicant: GERMANS BOADA, S.A., Rubi, Barcelona (ES)

(72) Inventor: Santiago SANCHEZ GOMEZ, Rubi, Barcelona (ES)

(21) Appl. No.: 15/763,792

(22) PCT Filed: Jul. 19, 2016
(86) PCT No.: PCT/ES2016/070545

§ 371 Date: Mar. 27, 2018

(30) Foreign Application Priority Data
Sep. 28, 2015 (ES) U201531063

(51) Int. Cl. B28D 1/24; B28D 7/00

(52) U.S. Cl. CPC B28D 1/24; B28D 7/00

(57) ABSTRACT

The invention relates to a ceramic cutter having liquid-cooling by immersion of the cutting disc, comprising: a support frame; an electric motor for actuating a cutting disc; a tray containing water for cooling the cutting disc by immersion; an auxiliary water tank, which is removable, disposed above the cooling tray and provided with a gravity-driven water outlet for discharging water into the cooling tray, said outlet being accommodated in the tray and being disposed at a height corresponding to a predetermined level of the water for cooling the cutting disc by immersion.

### OBJECT OF THE INVENTION

The object of the present invention is a ceramic cutter comprising at least: a support frame, an electric motor for actuating the cutting disc and a tray intended to contain water for cooling the cutting disc by immersion. This cutter has characteristics aimed at allowing for a comfortable and automatic repositioning of the water consumed in the cooling tray, maintaining a predetermined level inside the same.

### FIELD OF APPLICATION OF THE INVENTION

The present invention is applicable in the field of manufacturing ceramic cutters provided with means for cooling the cutting disc by immersion.

### STATE OF THE ART

Electric ceramic cutters usually have means for cooling the cutting disc and reducing the dust caused by the cutting.

Large electric cutters therefore incorporate a closed cooling circuit which sucks the water from a tank and projects it by means of a pump to the cutting area, then returning the water back to the tank.

In the case of electric cutters for smaller tasks, which are smaller in size, cheaper and lighter, liquid cooling means by immersion are used for the cutting disc.

Thus, below the cutting disc, these small electric cutters have a tray in which a predetermined water level must be maintained, sufficient to guarantee the immersion of the perimeter area of the cutting disc during the rotation of the same.

The drawback of this type of cooling is that the water is used during the use of the cutter, which makes it necessary for the operator to continuously be filling up the water needed to maintain a predetermined and suitable level to cool the disc. This is bothersome for the operator and translates to a loss of time in the operation.

### DESCRIPTION OF THE INVENTION

The ceramic cutter with liquid cooling by immersion of the cutting disc has particular constructive features aimed a allowing for the automatic replacement of the water consumed in the cooling tray, such that the water is maintained at a predetermined and suitable level in order to guarantee the cooling of the disc by immersion.

To this end, and in accordance with the invention, this cutter comprises an auxiliary water tank, which is removable, disposed above the cooling tray and provided with a gravity-driven water outlet on the inside thereof for discharging water into the cooling tray.

In a position of use of the auxiliary tank, said water outlet is accommodated in the tray and disposed at a height corresponding to a predetermined water level, suitable for cooling the cutting disc by immersion.

This arrangement of the outlet on the auxiliary tank guarantees that when the predetermined level of cooling water goes down inside the tray, it is automatically filled up with water from the auxiliary tank until reaching the predetermined level once again and coinciding with the outlet of said auxiliary tank.

By means of this improvement, the operator does not have to continuously leave go refill the water in the tray and when the water is used up from the auxiliary tank, rather, all the operator needs to do is remove the auxiliary tank and refill it, without having to transport the cutter to an outlet of a water supply.

The aforementioned outlet of the auxiliary tank can be made up of an angled tube, laterally coupled to the auxiliary tank, or by a hole defined on the lower area of the auxiliary tank.

### DESCRIPTION OF THE FIGURES

As a complement to the description being made, and for the purpose of helping to make the characteristics of the invention more readily understandable, this specification is accompanied by a set of drawings which, by way of illustration and not limitation, represent the following.

FIG. 1 shows a front perspective view of an exemplary embodiment of the ceramic cutter having liquid-cooling by immersion of the cutting disc, according to the invention, and wherein the outlet of the auxiliary tank is made up of an angled tube.

FIG. 2 corresponds to an exploded view of the cutter in the position of FIG. 1.

FIG. 3 shows a rear perspective view of the cutter of the previous figures.

FIG. 4 shows an exploded view of the cutter in the position shown in FIG. 3.

FIG. 5 shows a variant embodiment of the auxiliary tank of the preceding figures, wherein the angled tube is coupled to the auxiliary tank and has the possibility of rotating.

FIG. 6 shows a variant embodiment of the auxiliary tank wherein the outlet of the auxiliary tank is made up of a hole defined on the lower area of the same.

### PREFERRED EMBODIMENT OF THE INVENTION

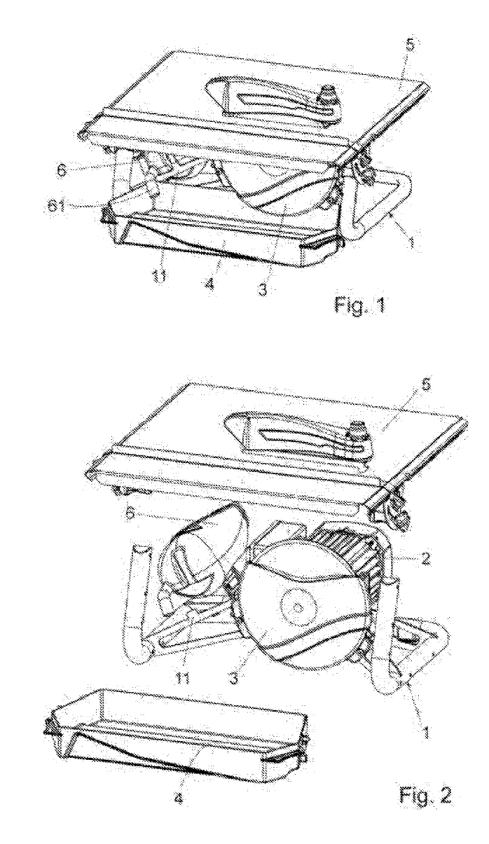

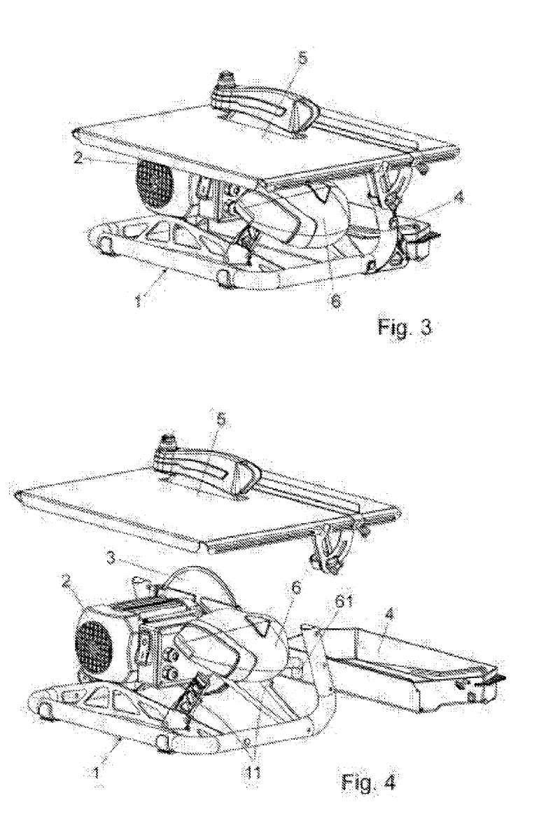

In the exemplary embodiment shown in FIGS. 1 to 4, the ceramic cutter comprises a support frame (1) on which an electric motor (2) for actuating a cutting disc (3), a tray (4) intended to contain water for cooling the cutting disc (3) by immersion and an upper table (5) for supporting the ceramic parts to be cut are all mounted.

According to the invention, the cutter comprises an auxiliary tank (6), which is removable, for the supplying water to the tray (4). Said auxiliary tank is positioned above the tray (4) and is provided with an outlet for supplying gravity-driven water to the tray (4).

In FIGS. 1 to 5, said outlet is made up of an angled tube (61) laterally coupled to the auxiliary tank (6).

As can be seen more clearly in FIG. 1, the lower mouth of the angled tube (61) is accommodated in the tray (4) and at a height corresponding to the predetermined level of cooling water maintained inside the tray (4); when the water level goes down inside the tray (4), leaving the lower end of the angled tube (61) exposed, the water, gravity-driven, comes down from inside the auxiliary tank (6) to the tray (4) until reaching the predetermined level once again.

As can be seen more clearly in FIGS. 1 and 2, the frame (1) comprises supports (11) for stably supporting and securing the auxiliary tank (6) in a position of use, such that the tank (6) can be easily placed in, and removed from, the ceramic cutter to make the refilling thereof easy.

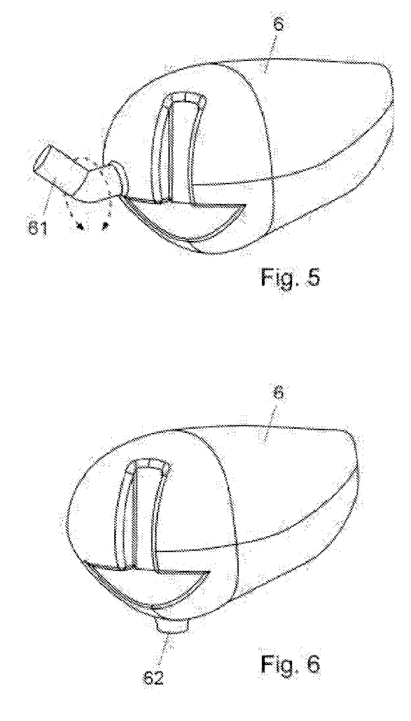

In FIG. 5, the angled tube (61) making up the water outlet, is coupled to the auxiliary tank (6) with the possibility of rotating between a position of use, in which it is disposed oriented towards the lower area, just as in FIGS. 1 and 2, and an inoperative position, in which it is disposed oriented towards the upper area, as shown in FIG. 5.

This possibility of the angled tube (61) rotating towards the lower area facilitates the transportation of the auxiliary tank when full, without discharging the water contained in the same; all that needs to be done is to rotate the angled tube (61) towards the lower position of use, once the auxiliary tank (6) is mounted in the cutter, to supply water to the tray (4).

In the example shown in FIG. 6, the outlet of the auxiliary tank (6) is made up of a hole (62) defined in the lower area of the same.

Having sufficiently described the nature of the invention, in addition to an example of preferred embodiment, it is hereby stated for the relevant purposes that the materials, shape, size and layout of the described elements may be modified, provided that it does not imply altering the essential characteristics of the invention claimed below.

1. A ceramic cutter having liquid-cooling by immersion of the cutting disc, said cutting disc comprising a support frame; an electric motor for actuating a cutting disc; a tray containing water for cooling the cutting disc by immersion; characterized in that it comprises an auxiliary water tank, which is removable, disposed above the cooling tray and provided with a gravity-driven water outlet for discharging water into the cooling tray, said outlet being accommodated in the tray and being disposed at a height corresponding to a predetermined level of the water for cooling the cutting disc by immersion.

2. The cutter according to claim 1, characterized in that the frame comprises supports for stably supporting and securing the auxiliary tank in a position of use.

3. The cutter according to claim 1, characterized in that the water outlet of the auxiliary tank is made up of an angled tube, laterally coupled to the same.

4. The cutter according to claim 2, characterized in that the angled tube for supplying water, is coupled to the auxiliary tank with the possibility of rotating between a position of use in which it is disposed oriented towards the lower area, and an inoperative position, in which it is disposed oriented towards the upper area.

5. The cutter according to claim 1, characterized in that the water outlet of the auxiliary water tank is made up of a hole defined on the lower area of the same.
